(19) United States
(12) Patent Application Publication
(10) Pub. No.: US 2005/0227075 A1
(43) Pub. Date: Oct. 13, 2005

(54) Derivatized nanoparticle comprising metal-ion sequestrant

(75) Inventor: Joseph F. Bringley, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/822,940

(22) Filed: Apr. 13, 2004

(51) Int. Cl. B32B 5/16

(52) U.S. Cl. 428/403; 977/DIG. 1

(57) ABSTRACT

This invention relates to a composition of matter comprising derivatized nanoparticles comprising inorganic nanoparticles having an attached metal-ion sequestrant, wherein said inorganic nanoparticles have an average particle size of less than 200 nm and the derivatized nanoparticles have a stability constant greater than 10¹⁰ with iron (III). It further relates to an article comprising said derivatized nanoparticles and to a method of removing iron from a liquid medium by contacting said medium with the derivatized nanoparticles.

### FIELD OF THE INVENTION

The present invention relates to a composition of matter comprising derivatized nanoparticles having a high-affinity and a high-capacity for metal-ions, and that are able to sequester or remove metal-ions from aqueous or biological environments.

### BACKGROUND OF THE INVENTION

Numerous materials and methods have been developed for providing antimicrobial properties to medical items, consumer articles and food packaging. Nearly all of the methods thus far developed rely on the release of bacteriocides or bacteriostats to kill unwanted microbes such as bacteria, viruses, yeast, etc. There is a general problem with this approach in that the released chemicals can be harmful to the user of said items, or may leach into aquatic or surrounding environments. Materials and methods which are cleaner and safer are needed to prevent microbial contamination and infectious disease.

Small concentrations of metal-ions may play an important role in biological processes. For example, Mn, Fe, Ca, Zn, Cu and Al are essential bio-metals, and are required for most, if not all, living systems. Metal-ions play a crucial role in oxygen transport in living systems, and regulate the function of genes and replication in many cellular systems. Calcium is an important structural element in the formation of bones and other hard tissues. Mn, Cu and Fe are involved in metabolism and enzymatic processes. At high concentrations, metals may become toxic to living systems and the organism may experience disease or illness if the level cannot be controlled. As a result, the availability and concentrations of metal-ions in biological environments is a major factor in determining the abundance, growth-rate and health of plant, animal and micro-organism populations.

It has been recognized that iron is an essential biological element, and that all living organisms require iron for survival and replication. Although the occurrence and concentration of iron is relatively high on the earth's surface, the availability of “free” iron is severely limited by the extreme insolubility of iron in aqueous environments. As a result, many organisms have developed complex methods of procuring “free” iron for survival and replication. Controlling the concentration of “free” iron in any biological system can, therefore, allow one to control the growth rates and abundance of micro-organisms. Such control can be of great use for treating sickness and disease, inhibiting bacterial growth, treating wounds, and providing for the general health of plant, animal, micro-organism and human populations. Indeed, iron “chelating” or “sequestering” drugs are used to treat iron deficiency in plants; and are used to treat diseases such as Cooley's anemia (thalassemia), sickle-cell anemia, and iron overload diseases in humans.

Metal-ions may exist as contaminants in environments such as drinking water, beverages, food, industrial effluents and public waste waters, and radioactive waste. Methods and materials for removing such contaminants are important for cleaning the environment(s) and providing for the safety of the general public.

U.S. Pat. No. 5,217,998 to Hedlund et al. describes a method for scavenging free iron or aluminum in fluids such as physiological fluids by providing in such fluids a soluble polymer substrate having a chelator immobilized thereon. A composition is described which comprises a water-soluble conjugate comprising a pharmaceutically acceptable water-soluble polysaccharide covalently bonded to deferoxamine, a known iron chelator. The conjugate is said to be capable of reducing iron concentrations in body fluids in vivo.

U.S. Pat. No. 6,156,234 to Meyer-Ingold et al. describes novel wound coverings which can remove interfering factors (such as iron ions) from the wound fluid of chronic wounds. The wound coverings may comprise iron chelators covalently bonded to a substrate such as cloth or cotton bandages.

U.S. Patent application U.S. 2003/0078209 A1 to Schmidt et al. describes solid porous compositions, substantially insoluble in water, comprising at least 25% by weight of an oxidized cellulose and having a significant capacity to bind iron. The invention also provides a method of sequestering dissolved iron from aqueous environments. The compositions may be used for the prevention or treatment of infections by bacteria or yeast.

U.S. Pat. No. 6,489,499 B 1 to King et al. describes novel compounds comprising siloxane modified carboxylic acid substituted amines.

The compounds of the invention are said to provide many of the desirable properties of ethylene diammine tetraacetic acid and its salts in a stationary phase. The stationary substrate may comprise silicate glass, silica, alumina, inorganic clays, etc. Markowitz et al. (J. Phys. Chem. B. 104, 10820 (2000)) describes metal chelating agents, such as carboxylic acid substituted amines, covalently bound to mesoporous silica. Tien (Chem. Mater. 11, 2141 (1999)) describes silica gels functionalized with carboxylic acid substituted amines, the functionalization of which was accomplished using siloxane modified carboxylic acid substituted amines. The usefulness of the material “as a stationary phase for chromatographic separation of metal-ions” was demonstrated.

The materials and methods described above, while capable of sequestering metal-ions, are limited in their capacity for several reasons. First, because the particle size of the substrate or of the stationary phase is large (>1 micron), only a limited amount of metal-ion sequestering agent can be applied to the surfaces of the substrate. This is especially true if the substrate or stationary phase contains no internal surfaces (i.e., are not porous). Metal-ion sequestering agent in excess of the available surface area, cannot be bound to the substrates surfaces, and therefore, will not be effective in sequestering or separating metal-ions from the contacting environment. Because sequestering media prepared as in the prior art have limited capacity, large amounts of material are required to effectively remove metal-ions and their application can be costly. Additionally, large particles strongly scatter light, and cannot be applied to transparent or colored surfaces or articles without rendering the surface or article opaque or white. This alters significantly the appearance of the article containing the sequestering agent and precludes the use of large particles in many applications.

Materials are needed that are able to target and remove specific metal-ions, while leaving intact the concentrations of beneficial metal-ions. Furthermore, materials are needed that have a high capacity for metal-ions and which provide for the efficient removal of metal-ions in a cost effective manner. Materials and methods are needed for sequestering metal-ions even in extremely low concentrations and removing metal-ion contaminants to levels below 100 parts per billion (ppb) and still further below 10 ppb. Materials and methods are needed for applying immobilized metal-ion sequestrants to numerous items and articles without significantly changing their color or appearance.

### SUMMARY OF THE INVENTION

This invention provides a composition of matter comprising derivatized nanoparticles comprising inorganic nanoparticles having an attached metal-ion sequestrant, wherein said inorganic nanoparticles have an average particle size of less than 200 nm and the derivatized nanoparticles have a stability constant greater than 10¹⁰ with iron (III). This invention further provides an article comprising said derivatized nanoparticles and a method of using said derivatized nanoparticles to remove metal-ions from a contacting environment.

The derivatized nanoparticles of the invention are able to target and remove specific metal-ions, while leaving intact the concentrations of beneficial metal-ions. Furthermore, they have a very high capacity for metal-ions and provide for the efficient removal of metal-ions in a cost effective manner. They can sequester metal-ions even in extremely low concentrations and remove metal-ion contaminants to levels below 100 parts per billion (ppb) and still further below 10 ppb. They can be utilized in numerous items and articles without significantly changing their color or appearance and they are easy to apply. The nanoparticles can be utilized to remove metal ions which are themselves contaminants, or they can be used to remove metal ions which are nutrients for biological contaminants. The nanoparticles do not release chemicals that can be harmful to humans or that may leach into aquatic or surrounding environments. Such materials and methods are cleaner and safer in preventing microbial contamination and infectious disease.

### DETAILED DESCRIPTION OF THE INVENTION

The derivatized nanoparticles of the invention may be used to remove metal-ions from a surrounding environment. In many instances, it is necessary to remove metal-ions from environments such as drinking water, food, biological fluids, industrial effluents and radioactive waste. The derivatized nanoparticles of the invention are placed in contact with the environment in an amount sufficient to bind the target metal-ion(s), and are then removed or separated from the environment, leaving the environment substantially free of the target metal-ion(s).

The invention provides a composition of matter comprising derivatized nanoparticles comprising inorganic nanoparticles having an attached metal-ion sequestrant, wherein said inorganic nanoparticles have an average particle size of less than 200 nm and the derivatized nanoparticles have a complex formation constant greater than 10¹⁰ with iron (III). It is preferred that the nanoparticles have an average particle size of less than 100 nm. It is further preferred that the nanoparticles have an average size of less than 20 nm. Preferably greater than 95% by weight of the nanoparticles are less than 100 nm and more preferably less than 50 nm. This is preferred because as the particle size becomes smaller, the particles scatter visible-light less strongly. Therefore, particles of this size can be applied to clear, transparent surfaces without causing a hazy or a cloudy appearance at the surface. This allows the particles of the present invention to be applied to consumer items, or other items without changing the appearance of that item.

The derivatized nanoparticles of the invention have a very high-capacity for binding metal ions. Particle sizes less than 100 nm and more preferably less than 20 nm are preferred because the capacity for binding metal-ions increases as the particles size decreases. It is preferred that the nanoparticles have a very high surface area, since this provides more surface with which to covalently bind the metal-ion sequestrant, also improving the capacity of the derivatized nanoparticles for binding metal-ions. It is preferred that the nanoparticles have a specific surface area of greater than 100 m²/g, and more preferably greater than 200 m²/g, and still more preferred greater than 300 m²/g. In a particularly preferred embodiment the nanoparticles have an average particle size of less than 20 nm and a specific surface area of greater than 300 m²/g.

The inorganic nanoparticles of the invention preferably comprise silica oxides, alumina oxides, boehmites, titanium oxides, zinc oxides, tin oxides, zirconium oxides, yttrium oxides, hafnium oxides, clays, or alumina silicates, and more preferably comprise silicon dioxide, alumina oxide, clays or boehmite. They may comprise combinations or mixtures of one or more components. The term “clay” is used to describe silicates and alumino-silicates, and derivatives thereof. Some examples of clays which are commercially available are montmorrillonite, hectorite, and synthetic derivatives such as laponite. Other examples include hydrotalcites, zeolites, alumino-silicates, and metal (oxy)hydroxides given by the general formula, MₐO_{b}(OH)_{c}, where M is a metal-ion and a, b and c are integers. It is preferred that the nanoparticles of the invention, before being derivatized, have a positive zeta potential, preferably greater than 25 mV.

The derivatized nanoparticles of the invention have an attached metal-ion sequestrant and have a high-affinity for metal-ions. They are able to sequester or remove metal-ions from aqueous or biological environments. Preferably, said metal-ion sequestrant has a high-affinity for iron, copper, zinc, aluminum or heavy metals. The term heavy metals refers to metals having an atomic weight greater than about 100 g/mol, such as Ag, Au, Tl, Pb, Cd, and also lanthanides such as La, Ce, Sm, Eu, and Gd, and radioactive metals such as Th, U and Pu. It is also preferred that the derivatized particles have a high-affinity for biologically significant metal-ions, such as, Zn, Cu, Mn and Fe. It is further preferred that the metal-ion sequestrant has a stability constant for iron greater than 10²⁰. It is still further preferred that the metal-ion sequestrant has a stability constant for iron greater than 10³⁰.

A measure of the “affinity” of metal-ion sequestrants for various metal-ions is given by the stability constant (also often referred to as critical stability constants, complex formation constants, equilibrium constants, or formation constants) of that sequestrant for a given metal-ion. Stability constants are discussed at length in “Critical Stability Constants”, A. E. Martell and R. M. Smith, Vols. 1-4, Plenum, N.Y. (1977), “Inorganic Chemistry in Biology and Medicine”, Chapter 17, ACS Symposium Series, Washington, D.C. (1980), and by R. D. Hancock and A. E. Martell, Chem. Rev. vol. 89, p. 1875-1914 (1989). The ability of a specific molecule or ligand to sequester a metal-ion may depend also upon the pH, the concentrations of interfering ions, and the rate of complex formation (kinetics). Generally, however, the greater the stability constant, the greater the binding affinity for that particular metal-ion. Often the stability constants are expressed as the natural logarithm of the stability constant. Herein the stability constant for the reaction of a metal-ion (M) and a sequestrant or ligand (L) is defined as follows:
M+nL⇄MLₙ

where the stability constant is βₙ=[MLₙ]/[M][L]ⁿ wherein [MLₙ] is the concentration of “complexed” metal-ion, [M] is the concentration of free (uncomplexed) metal-ion and [L] is the concentration of free ligand. The log of the stability constant is log βₙ, and n is the number of ligands which coordinate with the metal. It follows from the above equation that if βₙ is very large, the concentration of “free” metal-ion will be very low. Ligands with a high stability constant (or affinity) generally have a stability constant greater than 10¹⁰ or a log stability constant greater than 10 for the target metal. Preferably the ligands have a stability constant greater than 10¹⁵ for the target metal-ion. Table 1 lists common ligands (or sequestrants) and the natural logarithm of their stability constants (log βₙ) for selected metal-ions.

TABLE 1
Common ligands (or sequestrants) and the natural logarithm of their
stability constants (log βₙ) for selected metal-ions.

| Ligand | Ca | Mg | Cu(II) | Fe(III) | Al | Ag | Zn |
|---|---|---|---|---|---|---|---|
| alpha-amino | | | | | | | |
| carboxylates | | | | | | | |
| EDTA | 10.6 | 8.8 | 18.7 | 25.1 | | 7.2 | 16.4 |
| DTPA | 10.8 | 9.3 | 21.4 | 28.0 | 18.7 | 8.1 | 15.1 |
| CDTA | 13.2 | | 21.9 | 30.0 | | | |
| NTA | | | | 24.3 | | | |
| DPTA | 6.7 | 5.3 | 17.2 | 20.1 | 18.7 | 5.3 | |
| PDTA | 7.3 | | 18.8 | | | | 15.2 |
| citric Acid | 3.50 | 3.37 | 5.9 | 11.5 | 7.98 | 9.9 | |
| salicylic acid | | | | 35.3 | | | |
| Hydroxamates | | | | | | | |
| Desferrioxamine B | | | | 30.6 | | | |
| acetohydroxamic | | | | 28 | | | |
| acid | | | | | | | |
| Catechols | | | | | | | |
| 1,8-dihydroxy | | | | 37 | | | |
| naphthalene | | | | | | | |
| 3,6 sulfonic acid | | | | | | | |
| MECAMS | | | | 44 | | | |
| 4-LICAMS | | | | 27.4 | | | |
| 3,4-LICAMS | 16.2 | | | 43 | | | |
| 8-hydroxyquinoline | | | | 36.9 | | | |
| disulfocatechol | 5.8 | 6.9 | 14.3 | 20.4 | 16.6 | | |

EDTA is ehtylenediamine tetraacetic acid and salts thereof,
DTPA is diethylenetriaminepentaacetic acid and salts thereof,
DPTA is Hydroxylpropylenediaminetetraacetic acid and salts thereof,
NTA is nitrilotriacetic acid and salts thereof,
CDTA is 1,2-cyclohexanediamine tetraacetic acid and salts thereof,
PDTA is propylenediammine tetraacetic acid and salts thereof.
Desferrioxamine B is a commercially available iron chelating drug, desferal ®.
MECAMS, 4-LICAMS and 3,4-LICAMS are described by Raymond et al. in “Inorganic Chemistry in Biology and Medicine”, Chapter 18, ACS Symposium Series, Washington, D.C. (1980).
Log stability constants are from “Critical Stability Constants”, A. E. Martell and R. M. Smith, Vols. 1-4, Plenum Press, NY (1977); “Inorganic Chemistry in Biology and Medicine”, Chapter 17, ACS Symposium Series, Washington, D.C. (1980); R. D. Hancock and A. E. Martell, Chem. Rev. vol. 89, p. 1875-1914 (1989) and “Stability Constants of Metal-ion Complexes, The Chemical Society, London”, 1964.

In many instances, a disease may be associated with a particular metal-ion, either due to a deficiency of this metal-ion, or due to an overload (overdose) of this metal-ion. In such cases it may be desirable to synthesize a derivatized nanoparticle with a very high specificity or selectivity for a given metal-ion. Derivatized nanoparticles of this nature may be used to control the concentration of the target metal-ion and thus treat the disease or illness associated with this metal-ion. One skilled in the art may prepare such derivatized nanoparticles by selecting a metal-ion sequestrant having a high specificity for the target metal-ion. The specificity of a metal-ion sequestrant for a target metal-ion is given by the difference between the log of the stability constant for the target metal-ion, and the log of the stability constant for the interfering metal-ions. For example, if a treatment required the removal of Fe(III), but it was necessary to leave the Ca-concentration unaltered, then from Table 1,3,4-LICAMS would be a suitable choice since the difference between the log stability constants 43-16.2=26.8, is greatest of the ligands in Table 1.

It is preferred that the derivatized nanoparticles have a high stability constant for the target metal-ion(s). The stability constant for the derivatized nanoparticle will largely be determined by the stability constant for the attached metal-ion sequestrant. However, The stability constant for the derivatized nanoparticles may vary somewhat from that of the attached metal-ion sequestrant. Generally, it is anticipated that metal-ion sequestrants with high stability constants will give derivatized nanoparticles with high stability constants. For a particular application it may be desirable to have a derivatized nanoparticle with a high specificity for a particular metal-ion. In most cases, the derivatized nanoparticle will have a high specificity for a particular metal-ion if the stability constant for that metal-ion is about 10⁶ greater than for other ions present in the system No. It is further preferred that said metal-ion sequestrant has a high affinity for iron, and in particular iron(III). It is preferred that the stability constant of the sequestrant for iron(III) be greater than 10¹⁰.

Metal-ion sequestrants may be chosen from various organic molecules. Such molecules having the ability to form complexes with metal-ions are often referred to as “chelators”, “complexing agents”, and “ligands”. Certain types of organic functional groups are known to be strong “chelators” or sequestrants of metal-ions. It is preferred that the sequestrants of the invention contain alpha-amino carboxylates, hydroxamates, or catechol, functional groups. It is particularly preferred that the sequestrants of the invention contain hydroxamates, or catechol, functional groups. This is preferred because these sequestrants have very high stability constants with Fe(III), see Table 1.

Alpha-amino carboxylates have the general formula:
R—[N(CH₂CO₂M)-(CH₂)ₙ—N(CH₂CO₂M)₂]ₓ
where R is an organic group such as an alkyl or aryl group; M is H, or an alkali or alkaline earth metal such as Na, K, Ca or Mg, or Zn; n is an integer from 1 to 6; and x is an integer from 1 to 3. Examples of metal-ion sequestrants containing alpha-amino carboxylate functional groups include ethylenediaminetetraacetic acid (EDTA), ethylenediaminetetraacetic acid disodium salt, diethylenetriaminepentaacetic acid (DTPA), Hydroxylpropylenediaminetetraacetic acid (DPTA), nitrilotriacetic acid, triethylenetetraaminehexaacetic acid, N,N-bis(o-hydroxybenzyl) ethylenediamine-N,N diacteic acid, and ethylenebis-N,N′-(2-o-hydroxyphenyl)glycine.

Hydroxamates (or often called hydroxamic acids) have the general formula: 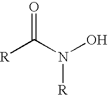
where R is an organic group such as an alkyl or aryl group. Examples of metal-ion sequestrants containing hydroxamate functional groups include acetohydroxamic acid, and desferroxamine B, the iron chelating drug desferal.

Catechols have the general formula: 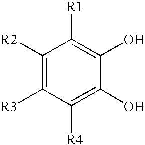
Where R1, R2, R3 and R4 may be H, an organic group such as an alkyl or aryl group, or a carboxylate or sulfonate group. Examples of metal-ion sequestrants containing catechol functional groups include catechol, disulfocatechol, dimethyl-2,3-dihydroxybenzamide, mesitylene catecholamide (MECAM) and derivatives thereof, 1,8-dihydroxynaphthalene-3,6-sulfonic acid, and 2,3-dihydroxynaphthalene-6-sulfonic acid.

In a preferred embodiment of the invention, the metal-ion sequestrant is attached to the nanoparticle, by reaction of the nanoparticle with a metal alkoxide intermediate of the sequestrant having the general formula.
M(OR)₄₋ₓR′ₓ;
wherein M is silicon, titanium, aluminum, tin, or germanium;
x is an integer from 1 to 3;
R is an organic group; and
R′ is an organic group containing an alpha-amino carboxylate, a hydroxamate, or a catechol, functional group. It is further preferred that R′ is an organic group containing a hydroxamate, or a catechol, functional group.

In a particular preferred embodiment the metal-ion sequestrant is attached to the nanoparticle by reaction of the nanoparticle with a silicon alkoxide intermediate having the general formula:
Si(OR)₄₋ₓR′ₓ;
wherein x is an integer from 1 to 3;
R is an alkyl group; and
R′ is an organic group containing an alpha amino carboxylate, a hydroxamate, or a catechol. The —OR-group attaches the silicon alkoxide to the core particle surface via a hydrolysis reaction with the surface of the particles. It is further preferred that R′ is an organic group containing a hydroxamate, or a catechol, functional group. Materials suitable for practice of the invention include N-(trimethoxysilylpropylethylenediamine triacetic acid, trisodium salt, N-(triethoxysilylpropylethylenediamine triacetic acid, trisodium salt, N-(trimethoxysilylpropylethylenediamine triacetic acid, N-(trimethoxysilylpropyldiethylenetriamine tetra acetic acid, N-(trimethoxysilylpropylamine diacetic acid, and metal-ion salts thereof.

It is preferred that substantially all (greater than 90%) of the metal-ion sequestrant is covalently bound to the nanoparticles, and is thus “anchored” to the nanoparticle. Metal-ion sequestrant that is not bound to the nanoparticles may dissolve and quickly diffuse through a system; and may be ineffective in removing metal-ions from the system. It is further preferred that the metal-ion sequestrant is present in an amount sufficient, or less than sufficient, to cover the surfaces of all nanoparticles. This is preferred because it maximizes the number of covalently bound metal-ion sequestrants, since once the surface of the nanoparticles is covered, no more covalent linkages may result.

The derivatized nanoparticles of the present invention may be prepared by general chemical synthetic methods. An aqueous or solvent based dispersion of the inorganic nanoparticles is prepared at a temperature below the boiling point of the mixture. To this dispersion, is then added the sequestrant having a chelating group and a functional group, which reacts with and forms a covalent bond to the surfaces of the inorganic nanoparticles. Alternatively, an intermediate may first be reacted with the nanoparticles and the intermediate subsequently reacted to form a metal-ion sequestrant.

In one embodiment, the invention provides an article comprising immobilized derivatized nanoparticles, said derivatized nanoparticles comprising inorganic nanoparticles having an attached metal-ion sequestrant, wherein said inorganic nanoparticles have an average particle size of less than 200 nm and the derivatized nanoparticles have a stability constant greater than 10¹⁰ with iron (III). Said derivatized nanoparticles are described in detail above. In one embodiment the derivatized nanoparticles are incorporated into the materials forming the article. In another embodiment the derivatized nanoparticles are contained in a layer further comprising a binder, said layer being on the surface of the article. The binder may be a polymer, resin or glue capable of adhering the derivatized nanoparticles to the surfaces of the article. Binders suitable for practice of the invention are polyvinyl alcohol, cellophane, water-based polyurethanes, polyester, polyethylene, polypropylene, nylon, high nitrile resins, polyethylene-polyvinyl alcohol copolymer, polystyrene, ethyl cellulose, cellulose acetate and cellulose nitrate, aqueous latexes, polyacrylic acid, and polystyrene sulfonate. The derivatized nanoparticles of the invention may be incorporated into, or applied to the surafces of such articles as filters, sponges, textiles, fibers, bandages, personal hygiene and medical items.

The invention further provides a method of removing metal-ions from an environment comprising contacting the environment with a composition comprising the above described derivatized nanoparticles comprising inorganic nanoparticles having an attached metal-ion sequestrant, wherein said inorganic nanoparticles have an average particle size of less than 200 nm and the derivatized nanoparticles have a stability constant greater than 10¹⁰ with iron (III). Upon contact with the environment, the targeted metal ions are sequestered by the immobilized derivatized nanoparticles and bound tightly to them. The nanoparticles may be immobilized in an article which is removed from the environment, thereby depleting or substantially reducing the amount of the targeted metal-ion in the environment Or the article may just bind the metal ions and not be removed, for example is the article is a container. It is preferred that the environment is a liquid medium. Preferably the target metal-ion concentration in the liquid medium is reduced to less than 100 ppb. In one embodiment the iron concentration in the liquid medium is reduced to less than 100 ppb, and more preferably the iron concentration in the liquid medium is reduced to less than 50 ppb.

The following examples are intended to illustrate, but not to limit the invention.

### EXAMPLES

Preparation of Derivatized Nanoparticles:

Colloidal dispersions of silica particles were obtained from ONDEO Nalco Chemical Company. NALCO® 1130 had a median particle size of 8 nm, a pH of 10.0, a specific gravity of 1.21 g/ml, a surface area of about 375 m²/g, and a solids content of 30 weight %. NALCO® 1140 had a median particle size of 11 nm, a pH of 9.7, a specific gravity of 1.29 g/ml, a surface area of about 200 m²/g, and a solids content of 40 weight %. NALCO® 1060 had a median particle size of 60 nm, a pH of 8.5, a specific gravity of 1.39 g/ml, a surface area of 50 m²/g, and a solids content of 50 weight %. NALCO® 2329 had a median particle size of 75 nm, a pH of about 9.5, a specific gravity of 1.29 g/ml, a surface area of 40 m²/g, and a solids content of 40 weight. Boehmite (AlOOH) was purchased from Sasol Inc. under the trade name Catapal 200® and had a specific surface area of about 100 m²/g. N-(trimethoxysilylpropylethylenediamine triacetic acid, trisodium salt was purchased from Gelest Inc., 45% by weight in water. Electrophoretic mobility measurements were made using a Zeta-Meter System 3.0+instrument (Zeta-Meter, Inc). Dispersions of the nanoparticles and derivatized nanoparticles (0.010 w/v %) were prepared using deionized distilled water. The pH was adjusted using 0.1M HCl or 0.1M KOH. The zeta potential (ζ) of the particles was computed as follows:
ζ=(4πηu_{E})/D
where η=the viscosity of the medium, u_{E}=electrophoretic mobility of the particle and D=the dielectric of the medium.

Derivatized nanoparticles A. To 267.00 g of silica NALCO® 1130 (30% solids) was added 200.00 g of distilled water and the contents mixed thoroughly using a mechanical mixer. To this suspension, was added 22.0 g of N-(trimethoxysilyl)propylethylenediamine triacetic acid, trisodium salt in 22.0 g distilled water with constant stirring at a rate of 5.00 ml/min. At the end of the addition the pH was adjusted to 7.1 with the addition of 4.04 g of glacial acetic acid, and the contents stirred for an hour at room temperature. Particle size analysis indicated an average particle size of 13 nm. The percent solids of the final dispersion was 17.3%.

Derivatized nanoparticles B. To 200.00 g of silica NALCO® 1140 (40% solids) was added 200.00 g of distilled water and the contents mixed thoroughly using a mechanical mixer. To this suspension, was added 22.0 g of N-(trimethoxysilyl)propylethylenediamine triacetic acid, trisodium salt in 22.0 g distilled water with constant stirring at a rate of 5.00 ml/min. At the end of the addition the pH was adjusted to 7.1 with the addition of 2.5 g of glacial acetic acid, and the contents stirred for an hour at room temperature. Particle size analysis indicated an average particle size of 20 nm. The percent solids of the final dispersion was 21.0%.

Derivatized nanoparticles C. Boehmite (AlOOH) 5.00 g was dispersed in 45.0 g distilled water to make a 10% by weight dispersion having an average particle size of about 70 nm. The zeta potential of the AlOOH nanoparticles was found to be about +40 mV at a pH of about 4.0, indicating that the particles have a positive charge on their surfaces. To this suspension, with continuous stirring, was added 0.65 g of N-(trimethoxysilylpropylethylenediamine triacetic acid, trisodium salt, (45% in water). At the end of the addition, the pH was adjusted to 6.0 with the addition of 4 drops of glacial acetic acid, and the contents stirred for an hour at room temperature. Particle size analysis indicated an average particle size of 110 nm. The percent solids of the final dispersion was about 10.5%. The zeta potential of the derivatized nanoparticles was found to be about −35 mV at a pH of about 8.0, indicating that the particles were negatively charged. The change of the particle charge from positive (underivatized) to negative (derivatized) is an indication that the surface of the particles is modified with metal-ion sequestrant.

### Example 1

A iron-sequestering suspension was prepared by the addition of 2.89 g derivatized nanoparticles A (0.5 g dry particles) to 7.11 g distilled water. To this suspension was then added 2.0 ml of a 500 ppm (parts per million) solution of Fe(NO₃)₃. The suspension was stirred for about 10 minutes and then filtered under-pressure through a dialysis filter having a molecular weight cut-off of 20,000 g/mol. The filtration effectively removes the nanoparticles and anything bound to them from the suspension. The recovered supernatant liquid was then examined for Fe concentration via inductively coupled plasma-atomic emission spectroscopy. The results are reported in Table 2.

### Example 2

Performed in an identical manner to example 1, except that 2.38 g derivatized nanoparticles B (0.5 g dry particles) and 7.62 g distilled water were used in place of the derivatized nanoparticles A and distilled water. The results are reported in Table 2.

### Comparison Example C-1

Performed in an identical manner to example 1, except that 1.00 g of chelex 100® (Biorad) and 9.00 g distilled water were used in place of the derivatized nanoparticles A and distilled water. The results are reported in Table 2.

### Example 3

A “model” biological liquid medium was prepared as follows: 12.5 g of sucrose, 12.5 g of glucose, 0.25 g of NaCl and 0.125 g of citric acid, and 16.0 ml of a 500 ppm solution of Fe³⁺ were carefully dissolved in 484.0 ml of pure distilled water to produce a solution having: 5% sucrose, 5% glucose, 1000 ppm NaCl, 500 ppm citric acid and 16 ppm iron. The pH of the model beverage was adjusted to 4.0 with the addition of a few drops of 1.0 N NaOH. To 8.8 ml of the model beverage above was added 0.58 g derivatized nanoparticles A (0.10 g dry particles). The suspension was stirred for about 10 minutes and then filtered under-pressure through a dialysis filter having a molecular weight cut-off of 20,000. The filtration effectively removes the nanoparticles and anything bound to them from the suspension. The recovered supernatant liquid was then examined for Fe concentration via inductively coupled plasma-atomic emission spectroscopy. The results are reported in Table 2.

### Example 4

Performed in an identical manner to example 3, except that 0.48 g derivatized nanoparticles B (0.10 g dry particles) were used in place of the derivatized nanoparticles A. The results are reported in Table 2.

### Comparison Example C-1

Performed in an identical manner to example 3, except that 1.00 g of a 10% dispersion of chelex 100® (Biorad) were used in place of the derivatized nanoparticles A. The results are reported in Table 2.

TABLE 2
Iron sequestration from aqueous solutions (examples 1-2, C-1) and from
a model biological liquid medium at pH 4.0 (examples 3-4, C-2).

| | | [Fe] after |
|---|---|---|
| Example or | initial [Fe] | treatment |
| comparison | (ppm) | (ppm) |
| 1 | 83.3 | 0.58 |
| 2 | 83.3 | 0.72 |
| C-1 | 83.3 | 2.6 |
| 3 | 16 | 1.4 |
| 4 | 16 | 0.56 |
| C-2 | 16 | 8.2 |

The data of Table 2 show that the derivatized nanoparticles of the invention are able to remove more iron from aqueous solutions than commercially available iron chelators (comparison example). The derivatized nanoparticles of the invention thus have a greater metal-ion binding capacity when compared to the comparison examples. The data of Table 2 further show that the derivatized nanoparticles of the invention are able to remove more iron from a model biological liquid medium, when compared to commercially available iron chelators (comparison example). The derivatized nanoparticles of the invention have a high-affinity for Fe ions even though the pH is quite low, about 4.0. In contrast, the iron chelators of the comparison example have a relatively low-affinity for iron ions at pH 4.0. The derivatized nanoparticles of the invention thus have a greater metal-ion binding capacity when compared to the comparison examples, particularly in biological or nutrient-rich media having a low pH.

The invention has been described in detail with particular reference to certain preferred embodiments thereof, but it will be understood that variations and modifications can be effected within the spirit and scope of the invention.

1. A composition of matter comprising derivatized nanoparticles comprising inorganic nanoparticles having an attached metal-ion sequestrant, wherein said inorganic nanoparticles have an average particle size of less than 200 nm and the derivatized nanoparticles have a stability constant greater than 10¹⁰ with iron (III).

2. The composition of matter of claim 1 wherein said inorganic nanoparticles have an average particle size of less than 100 nm.

3. The composition of matter of claim 1 wherein said inorganic nanoparticles have an average particle size of less than 20 nm.

4. The composition of matter of claim 1 wherein said inorganic nanoparticles comprise silica oxides, alumina oxides, boehmites, titanium oxides, zinc oxides, tin oxides, zirconium oxides, yttrium oxides, hafnium oxides, clays, or alumina silicates.

5. The composition of matter of claim 3 wherein said inorganic nanoparticles comprise silicon dioxide, alumina oxide, clays or boehmite.

6. The composition of matter of claim 1 wherein said metal-ion sequestrant has a high stability constant for copper, zinc, aluminum or heavy metals.

7. The composition of matter of claim 1 wherein said metal-ion sequestrant has a stability constant for iron greater than 10²⁰.

8. The composition of matter of claim 1 wherein said metal-ion sequestrant has a stability constant for iron greater than 10³⁰.

9. The composition of matter of claim 1 wherein said metal-ion sequestrant comprises an alpha amino carboxylate functional group.

10. The composition of matter of claim 1 wherein said metal-ion sequestrant comprises a hydroxamate or a catechol functional group.

11. The composition of matter of claim 1 wherein the metal-ion sequestrant is attached to the nanoparticle, by reacting the nanoparticle with a metal alkoxide intermediate of the sequestrant having the general formula:
M(OR)₄₋ₓR′ₓ;
wherein M is silicon, titanium, aluminum, tin, or germanium;
x is an integer from 1 to 3;
R is an organic group; and
R′ is an organic group containing an alpha amino carboxylate, a hydroxamate, or a catechol functional group.

12. The composition of claim 11 wherein R′ is a hydroxamate, or a catechol functional group.

13. The composition of matter of claim 1 wherein said metal-ion sequestrant is attached to the nanoparticle by reacting the nanoparticle with a silicon alkoxide intermediate of the sequestrant having the general formula:
Si(OR)₄₋ₓR′ₓ;
wherein x is an integer from 1 to 3;
R is an alkyl group; and
R′ is an organic group containing an alpha amino carboxylate, a hydroxamate, or a catechol functional group.

14. The composition of claim 13 wherein R′ is a hydroxamate, or a catechol functional group.

15. The composition of matter of claim 1 wherein said nanoparticles have a specific surface area of greater than 100 m²/g.

16. The composition of matter of claim 1 wherein said nanoparticles have a specific surface area of greater than 200 m²/g.

17. The composition of matter of claim 1 wherein said nanoparticles have a specific surface area of greater than 300 m²/g.

18. The composition of matter of claim 3 wherein said nanoparticles have a specific surface area of greater than 300 m²/g.

19. The composition of matter of claim 1 wherein substantially all the metal-ion sequestrant is covalently bound to the nanoparticles.

20. The composition of matter of claim 1 wherein greater than 95% by weight of the nanoparticles have a particle size of less than 100 nm

21. The composition of matter of claim 1 wherein greater than 95% by weight of the nanoparticles have a particle size of less than 50 nm.

22. An article comprising immobilized derivatized nanoparticles, said derivatized nanoparticles comprising inorganic nanoparticles having an attached metal-ion sequestrant, wherein said inorganic nanoparticles have an average particle size of less than 200 nm and the derivatized nanoparticles have a stability constant greater than 10¹⁰ with iron (III).

23. The article of claim 22 wherein the derivatized nanoparticles are contained in a layer further comprising a binder, said layer being located on the surface of the article.

24. The article of claim 22 wherein the derivatized nanoparticles are incorporated into the materials forming the article.

25. The article of claim 22 wherein said inorganic nanoparticles have an average particle size of less than 100 nm.

26. The article of claim 22 wherein said inorganic nanoparticles have an average particle size of less than 20 nm.

27. The article of claim 22 wherein said inorganic nanoparticles comprise silica oxides, alumina oxides, boehmites, titanium oxides, zinc oxides, tin oxides, zirconium oxides, yttrium oxides, hafnium oxides, clays, or alumina silicates.

28. The article of claim 22 wherein said inorganic nanoparticles comprise silicon dioxide, alumina oxide, clays or boehmite.

29. The article of claim 22 wherein said metal-ion sequestrant has a high stability constant for copper, zinc, aluminum or heavy metals.

30. The article of claim 22 wherein said metal-ion sequestrant has a stability constant for iron greater than 10²⁰.

31. The article of claim 22 wherein said metal-ion sequestrant has a stability constant for iron greater than 10³⁰.

32. The article of claim 22 wherein said metal-ion sequestrant comprises an alpha amino carboxylate functional group.

33. The article of claim 22 wherein said metal-ion sequestrant comprises a hydroxamate or a catechol functional group.

34. The article of claim 22 wherein the metal-ion sequestrant is attached to the nanoparticle, by reacting the nanoparticle with a metal alkoxide intermediate of the sequestrant having the general formula:
M(OR)₄₋ₓR′ₓ;
wherein M is silicon, titanium, aluminum, tin, or germanium;
x is an integer from 1 to 3;
R is an organic group; and
R′ is an organic group containing an alpha amino carboxylate, a hydroxamate, or a catechol functional group.

35. The article of claim 34 wherein R′ is a hydroxamate, or a catechol functional group.

36. The article of claim 22 wherein said metal-ion sequestrant is attached to the nanoparticle by reacting the nanoparticle with a silicon alkoxide intermediate of the sequestrant having the general formula:
Si(OR)₄₋ₓR′ₓ;
wherein x is an integer from 1 to 3;
R is an alkyl group; and
R′ is an organic group containing an alpha amino carboxylate, a hydroxamate, or a catechol functional group.

37. The article of claim 36 wherein R′ is a hydroxamate, or a catechol functional group.

38. The article of claim 22 wherein said inorganic nanoparticles have a specific surface area of greater than 100 m²/g.

39. The article of claim 22 wherein said nanoparticles have a specific surface area of greater than 200 m²/g.

40. The article of claim 22 wherein said nanoparticles have a specific surface area of greater than 300 m²/g.

41. The article of claim 26 wherein said nanoparticles have a specific surface area of greater than 300 m²/g.

42. The article of claim 22 wherein substantially all the metal-ion sequestrant is covalently bound to the nanoparticles.

43. The article of claim 22 wherein greater than 95% by weight of the inorganic nanoparticles have a particle size of less than 100 nm.

44. The article of claim 22 wherein greater than 95% by weight of the inorganic nanoparticles have a particle size of less than 50 nm.

45. A method of removing target metal-ions from an environment comprising contacting the environment with a composition comprising derivatized nanoparticles comprising inorganic nanoparticles having an attached metal-ion sequestrant, wherein said inorganic nanoparticles have an average particle size of less than 200 nm and the derivatized nanoparticles have a stability constant greater than 10¹⁰ with iron (III).

46. The method of claim 45 wherein the environment is a liquid medium.

47. The method of claim 45 wherein the target metal-ion concentration in the liquid medium is reduced to less than 100 ppb.

48. The method of claim 47 wherein the target metal ion is iron.

49. The method of claim 48 wherein the iron concentration in the liquid medium is reduced to less than 50 ppb.

50. The method of claim 45 wherein said inorganic nanoparticles have an average particle size of less than 100 nm.

51. The method of claim 45 wherein said inorganic nanoparticles have an average particle size of less than 20 nm.

52. The method of claim 45 wherein said metal-ion sequestrant has a high stability constant for copper, zinc, aluminum or heavy metals.

53. The method of claim 45 wherein said metal-ion sequestrant has a stability constant for iron greater than 10²⁰.

54. The method of claim 45 wherein said metal-ion sequestrant has a stability constant for iron greater than 10³⁰.

55. The method of claim 45 wherein said metal-ion sequestrant comprises an alpha amino carboxylate functional group.

56. The method of claim 45 wherein said metal-ion sequestrant comprises a hydroxamate or a catechol functional group.

57. The method of claim 45 wherein said nanoparticles have a specific surface area of greater than 100 m²/g.

58. The method of claim 45 wherein said nanoparticles have a specific surface area of greater than 200 m²/g.

59. The method of matter of claim 45 wherein said nanoparticles have a specific surface area of greater than 300 m²/g.

60. The method of matter of claim 51 wherein said nanoparticles have a specific surface area of greater than 300 m²/g.

61. The method of claim 45 wherein greater than 95% by weight of the nanoparticles have a particle size of less than 100 nm.

62. The method of claim 45 wherein greater than 95% by weight of the nanoparticles have a particle size of less than 50 nm.
